(19) United States
(12) Patent Application Publication
(10) Pub. No.: US 2011/0053109 A1
(43) Pub. Date: Mar. 3, 2011

(54) ORTHODONTIC ANCHORING SCREW

(76) Inventors: Holger Zipprich, Darmstadt (DE); Cornelius Geist, Darmstadt (DE)

(21) Appl. No.: 12/663,631

(22) PCT Filed: Jun. 11, 2008
(86) PCT No.: PCT/EP08/04669

§ 371 Date: Jun. 21, 2010

(30) Foreign Application Priority Data
Jun. 11, 2007 (DE) 10-2007-027-606.2

(51) Int. Cl. A61C 7/00

(52) U.S. Cl. 433/18

(57) ABSTRACT

A fixing wire, in particular for applying treatment forces to a tooth, is intended to be protected in an extremely simple manner against translatory and rotational displacements and against being dislodged, with the mounting and dismantling time kept short. For this purpose, the fixing wire has a widened region produced by plastic deformation, for the longitudinal fixing thereof in a corresponding fixing recess of an orthodontic anchoring screw.

The invention relates to a fixing wire, in particular a fixing wire for applying treatment forces to a tooth.

The main focus in orthodontics is the specific and controlled movement and displacement of teeth in therapeutic treatment methods. In this connection, such a translatory or even rotational movement of a tooth may only be achieved by the action of external forces, which are correspondingly exerted on the tooth in order to move the tooth within the jaw. To maintain a firm fit in the jaw bone, the tooth is subjected to the external force over a long time period. This force is thus transmitted to the tooth via suitable fixing means, until said tooth adopts the desired position and/or orientation in the oral cavity. The tooth is generally subjected to an external force, therefore, via clamps, wires, rubber bands or other suitable force-exerting elements. To this end, however, the force-exerting elements always have to be correspondingly fixed in the oral cavity.

Such a support of the force-exerting elements is generally carried out on one or more teeth, for example two or more teeth positioned relative to one another in a suitable manner being connected to one another via a clamping element, which is subsequently tensioned, for example. Such an approach, however, has the drawback that in this case, due to the design, two or more teeth are subjected to forces in a symmetrical manner and said teeth are displaced and/or twisted in an undesirable manner with the tooth to be treated, although this is only intended and desired for the tooth to be treated. The specific displacement during the treatment of the one tooth is thus inevitably associated with an undesirable, or only partially acceptable, alteration of the position of the other tooth or the other teeth, which are used for fixing the force-exerting elements.

In order to counteract this, anchoring may also alternatively be carried out via one-piece or multi-piece temporary screws, so-called orthodontic anchoring screws, which may be temporarily inserted into the jaw bone and may be removed again after successful displacement of the tooth or a plurality of teeth. In contrast with dental implant materials which are designed for permanent integration into the jaw bone and stable ingrowth over the longest possible period of time, such anchoring screws have to be inserted in such a way that subsequent removal from the bone remains possible. However, with the use of such anchoring screws, it is imperative to remember that during the active treatment phase, i.e. during the actual force introduction of the desired forces into the tooth requiring treatment, a reliable and load-bearing fit of the respective anchoring screw provided as an abutment is essential.

Thus, care should be taken that, after being screwed in, the anchoring screw has a stability in the bone which is based on the tension of the screw with the bone. This stability is also denoted as primary stability. However, on the one hand, as the bone reacts to mechanical stresses and is displaced, this stability initially decreases with increased wearing time, as a result of the displacements. However, on the other hand, when the screw material starts to be colonised with cells, in particular bone cells, an additional stability is also created by the bonding of the cells with the screw material. This is known as oseointegration. The stability in the bone should be adequate during the entire period of insertion, in order to suffice as an abutment for the displacement of at least one tooth.

Where there are foreign bodies in the oral cavity, such as for example the orthodontic anchoring screw, which in addition to the teeth and soft tissue, i.e. the natural anatomical conditions in the mouth, represent an additional raised part and/or shape and thus alter the natural anatomical conditions, the surrounding soft tissue is additionally stressed. During the chewing process, the soft tissue, in particular that of the cheeks and tongue, is passed over the teeth. However, if a foreign body is located on the movement path of the soft tissue of the cheeks or the tongue, said movement sequence is interrupted. Even with deburred shapes, injuries and infections of the surrounding soft tissue frequently result. Only after a few weeks can the surrounding soft tissue become accustomed to the new situation, so that pain for the patient and infections of the soft tissue may be reduced. Thus, sharp and sharp-edged shapes should be avoided for all foreign bodies additionally introduced in the mouth and the radii kept as large as possible so that the transitions are formed as smoothly as possible.

For specific action on a tooth by a force and/or a torque via wires, rubber bands, clamps and other force-exerting elements, these elements have to be fixed to the orthodontic anchoring screw in the direction of the exerted force or counter to the exerted force. This fixing may be carried out in different ways. When the wires are inserted into recesses provided for them in the form of grooves, this is referred to as ligation. The ligation is intended to prevent the wires from being dislodged and/or prematurely loosened and released from the screw. If a bore exists outside the axis of the screw axis, the wire may be guided through said bore and no longer be dislodged as it would be in the case of a groove. A drawback of this embodiment is that, as a result of production, the bores have a round diameter and thus the wire is no longer secured against rotational displacement. Moreover, it is very awkward and difficult for the doctor providing treatment to pass the wire through the bore. Further possibilities for securing the wire during ligation in grooves of the heads of orthodontic anchoring screws are bonding, securing with a rubber band or winding a wire around the screw head.

If a round wire is bonded into a groove, it is secured against being dislodged. However, as tensile loading and rotational loading considerably stress the bond, there is a risk of the wire being released from the fastening and from the orthodontic anchoring screw during use. If, however, it is a rectangular wire, said wire is sufficiently protected against rotational loading inside the groove and there is only a risk of release from the fastening in the case of a tensile load. A further drawback of this method is that bonding the wire makes subsequent dismantling considerably more difficult and the adhesive used could cause undesirable irritation of the surrounding soft tissue.

If the wire is wound around the head of the orthodontic anchoring screw, and optionally additionally secured by an adhesive, then if a wire with a round cross section is used there is hardly any risk of release and it is sufficiently secured against being dislodged and against translatory and rotational displacements. Winding a wire of rectangular cross section around the head of the orthodontic anchoring screw is substantially more difficult but can be carried out by the doctor providing the treatment and subsequently also protects the wire from undesired displacement or being dislodged from the groove. However, a drawback of this fastening method is that in both embodiments of the wires there is the risk that winding around the head of the orthodontic anchoring screw could lead to pointed and sharp-edged elements of the wire irritating or even damaging the surrounding soft tissue and thus causing the patient pain. An infection of the soft tissue is even possible. Moreover, winding around the screw head unnecessarily increases the treatment time and makes dismantling more difficult.

The wire may also be secured against being dislodged by fastening a rubber band to the head of the orthodontic anchoring screw in a specifically provided recess in the form of a groove at least partially surrounding the head. Injuries or infections to the soft tissue may thus be avoided and/or reduced by correct positioning of the wire and of the rubber band. Wires with a rectangular cross section are additionally sufficiently secured against rotational displacement due to the geometric shape of the groove. A drawback of this method is that the wires cannot be sufficiently secured against translatory displacement. Such securing could take place by additional bonding. This would, however, make dismantling of the wire more difficult after treatment and, as already disclosed above, possibly irritate the surrounding soft tissue. Additionally, the treatment time would be increased by the use of two consecutive operating steps.

The object of the invention is therefore to provide a fastening means for force-exerting elements on anchoring screws, in orthodontic treatment methods, which is protected in an extremely simple manner against translatory and rotational displacements and against being dislodged, with the mounting and dismantling time kept short.

This object is achieved according to the invention in that the fixing wire has a widened region produced by plastic deformation, for the longitudinal fixing thereof in a corresponding fixing recess of an orthodontic anchoring screw.

Advantageous embodiments of the invention form the subject-matter of the sub-claims.

An embodiment of the invention is described in more detail with reference to the drawings, in which:

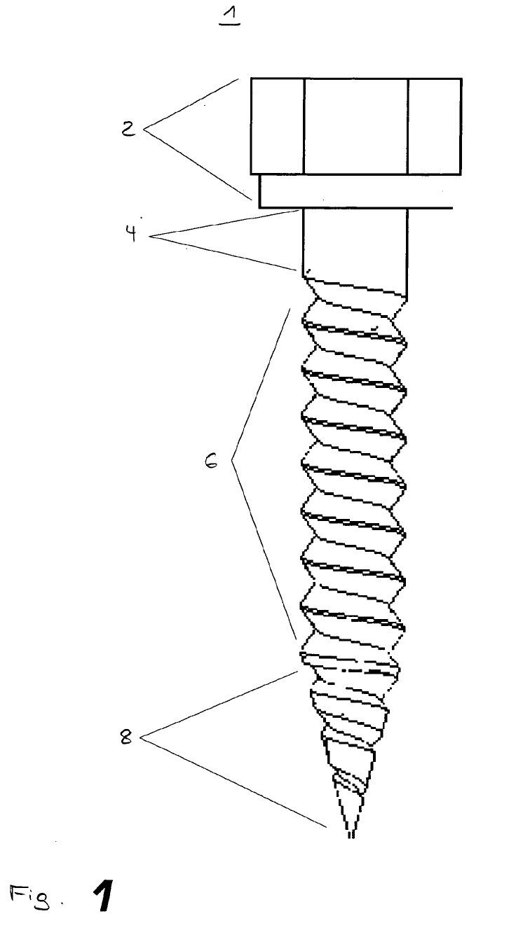

FIG. 1 shows an orthodontic anchoring screw,

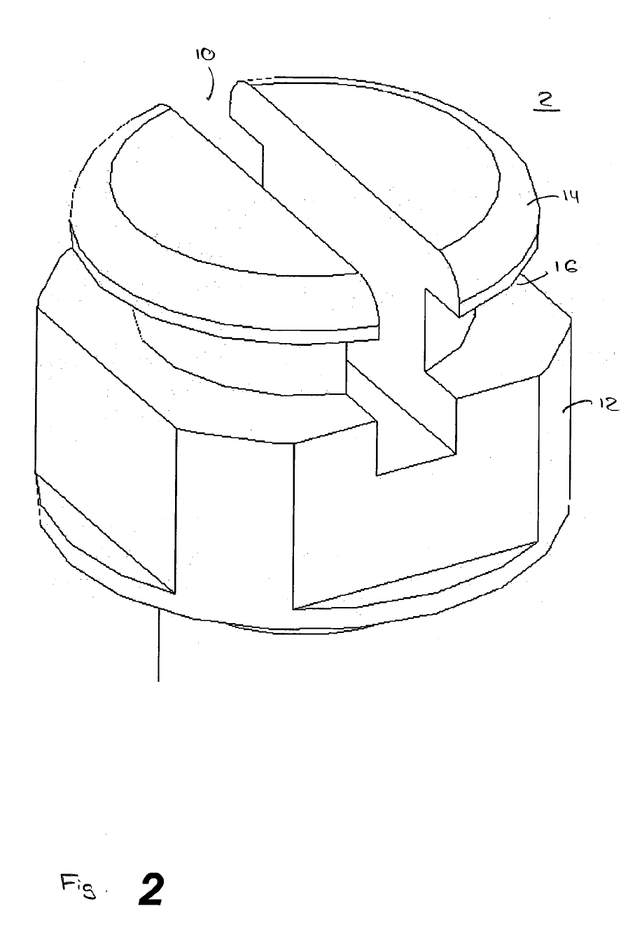

FIG. 2 shows a screw head of an orthodontic anchoring screw,

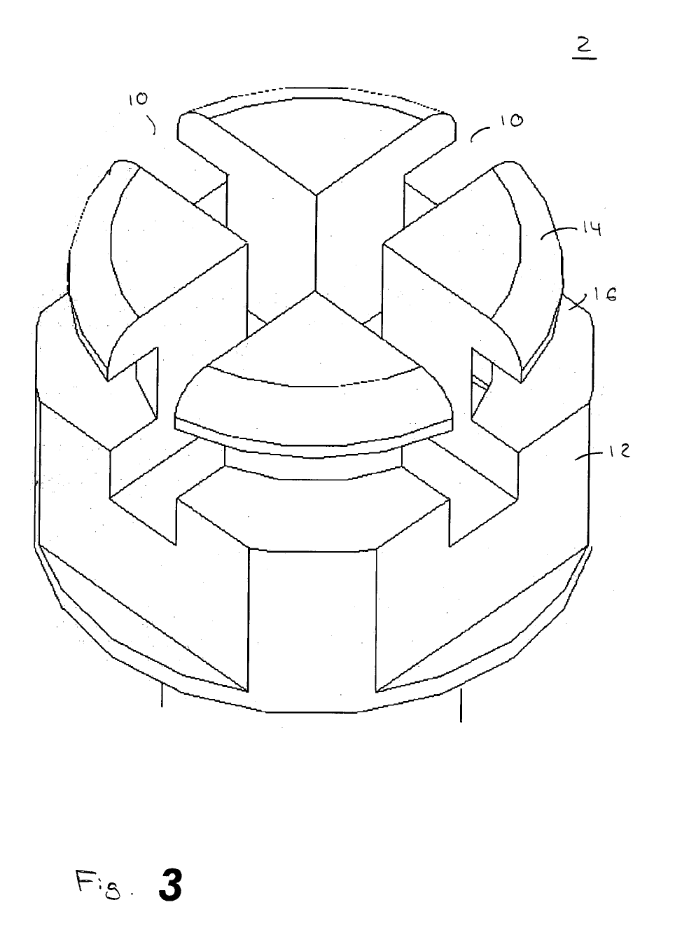

FIG. 3 shows a screw head with a cross-shaped groove,

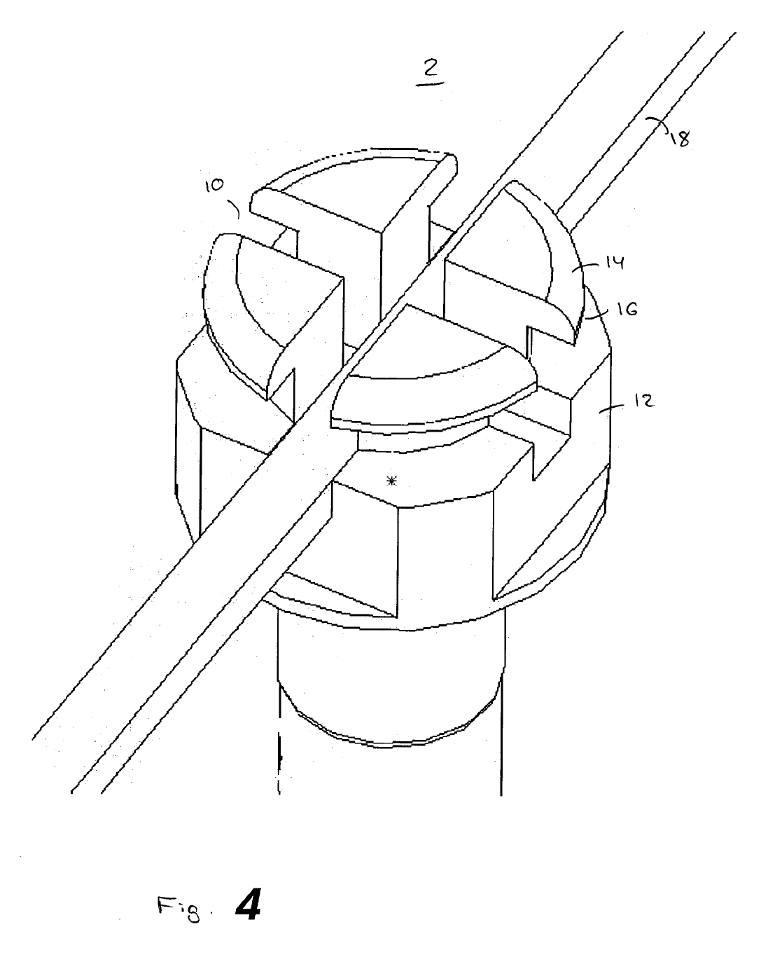

FIG. 4 shows a screw head with the inserted fixing wire,

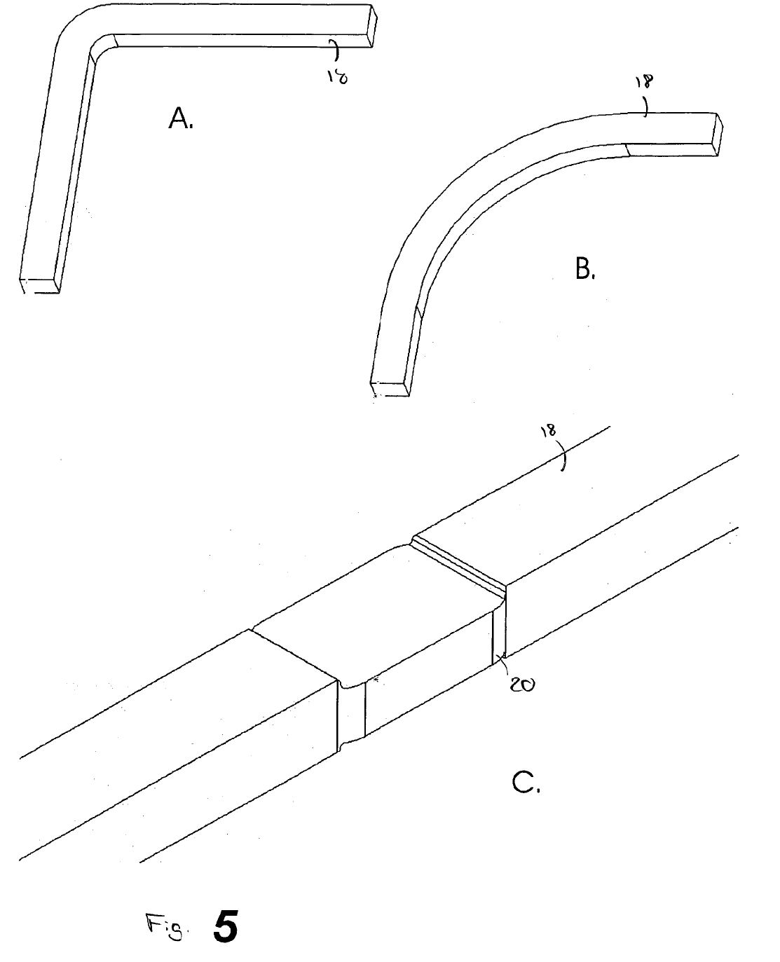

FIG. 5-FIG. 7 show different embodiments of the fixing wire,

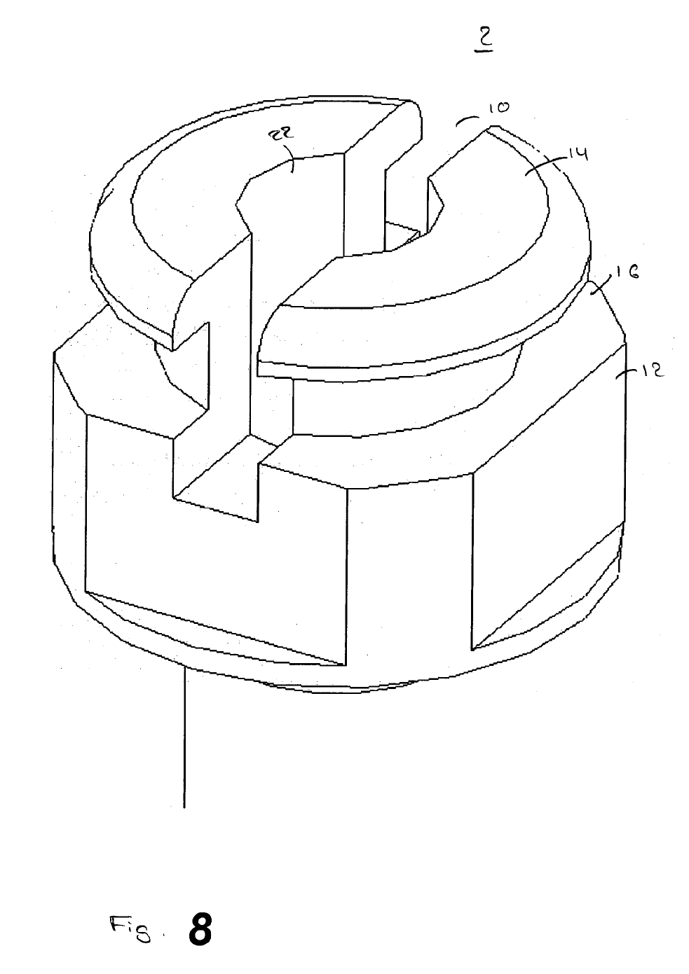

FIG. 8 shows a screw head with a fixing recess,

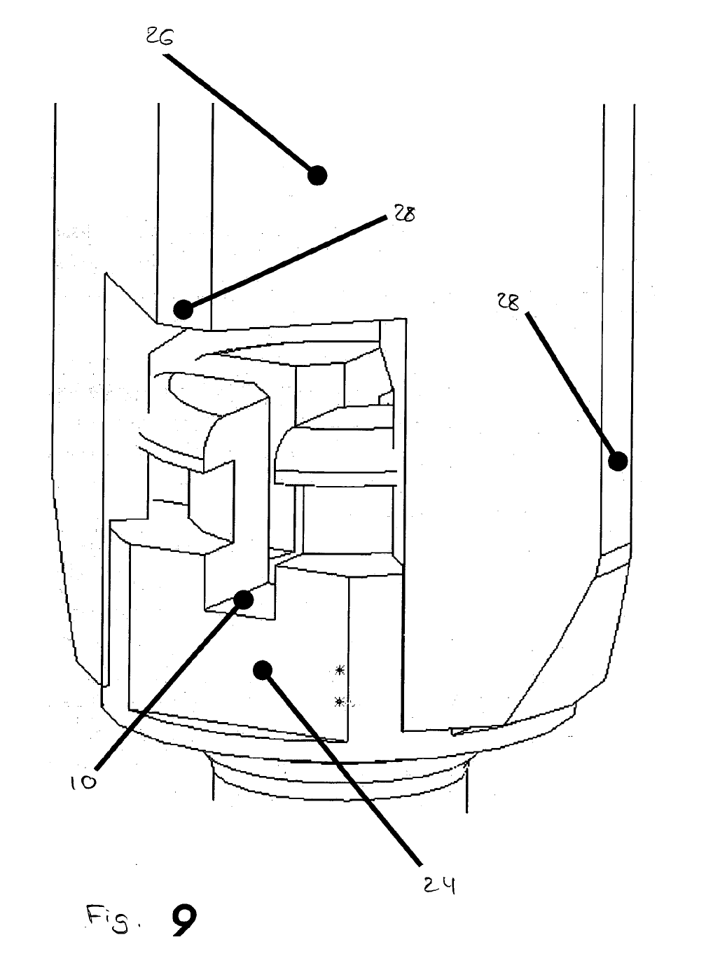

FIG. 9 shows a tool for receiving and aligning the screw head,

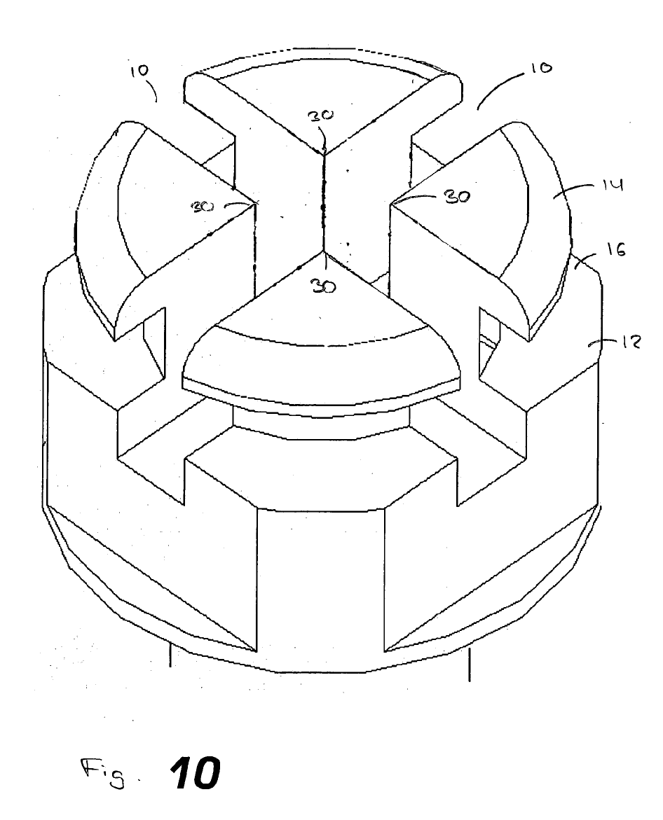

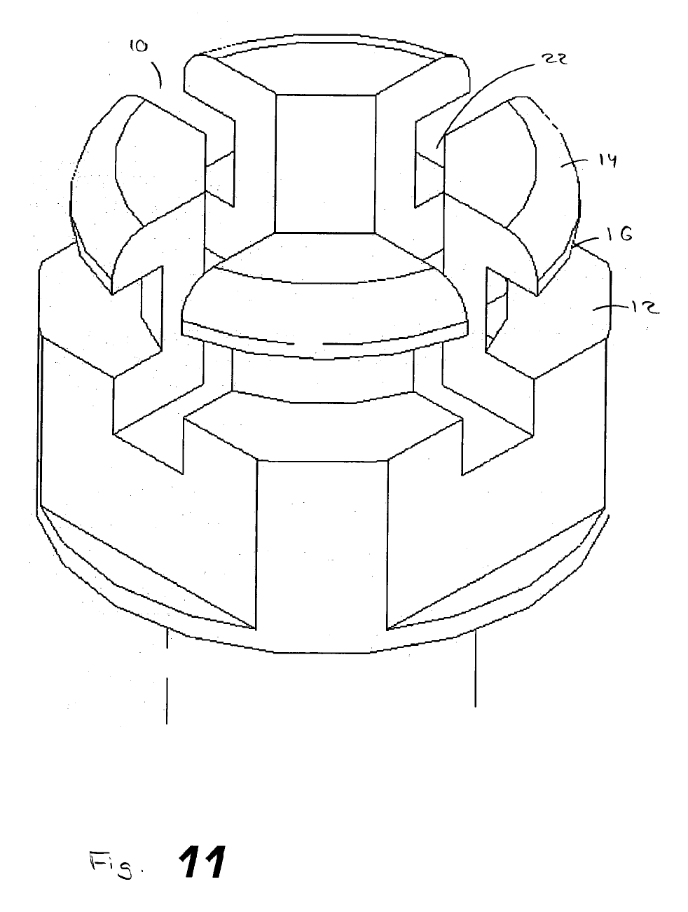

FIG. 10-FIG. 13 show different screw heads with different central bores,

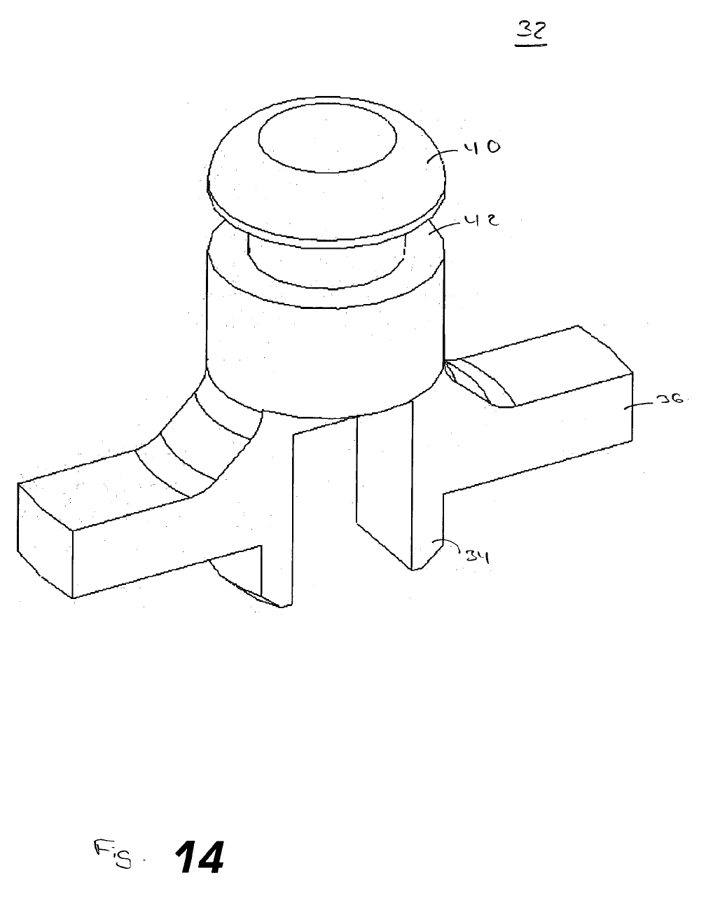

FIG. 14 shows a fixing pin,

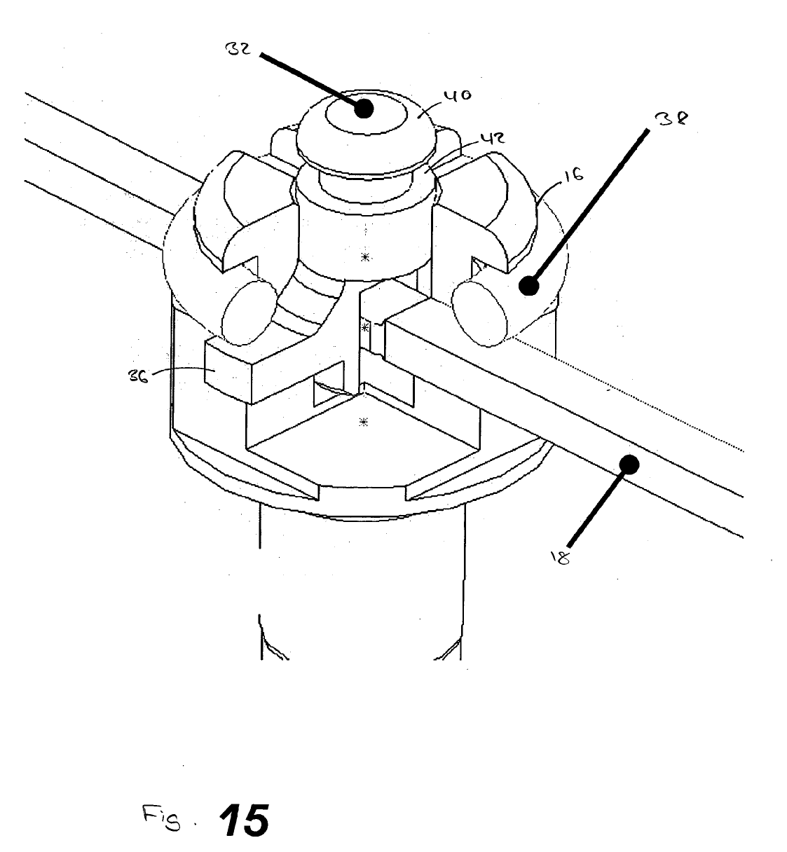

FIG. 15 shows a fixing pin on a screw head,

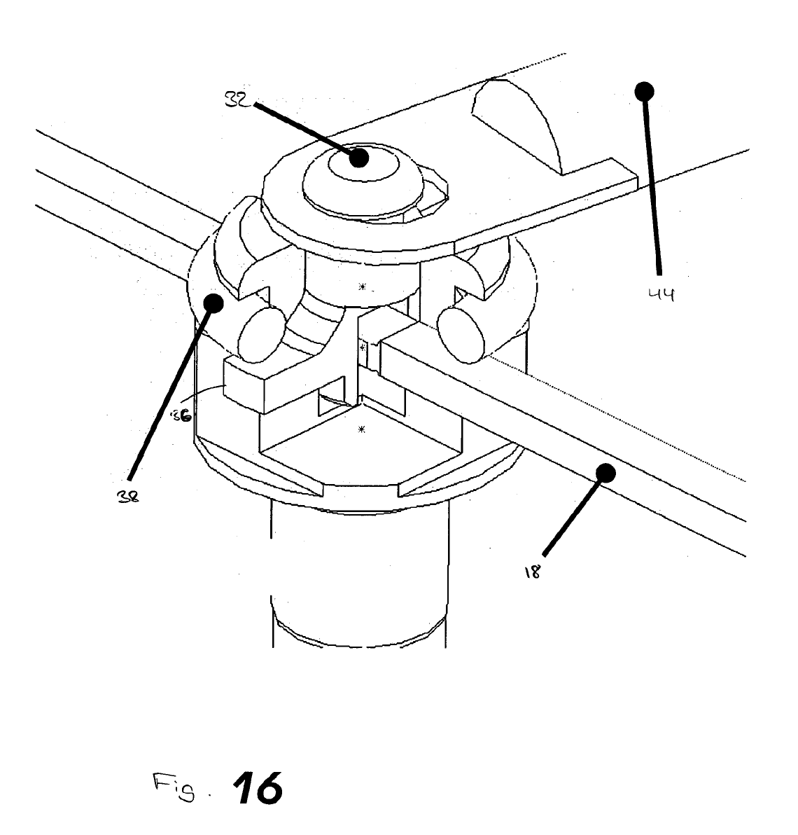

FIG. 16 shows a fixing pin with a clamping element on a screw head,

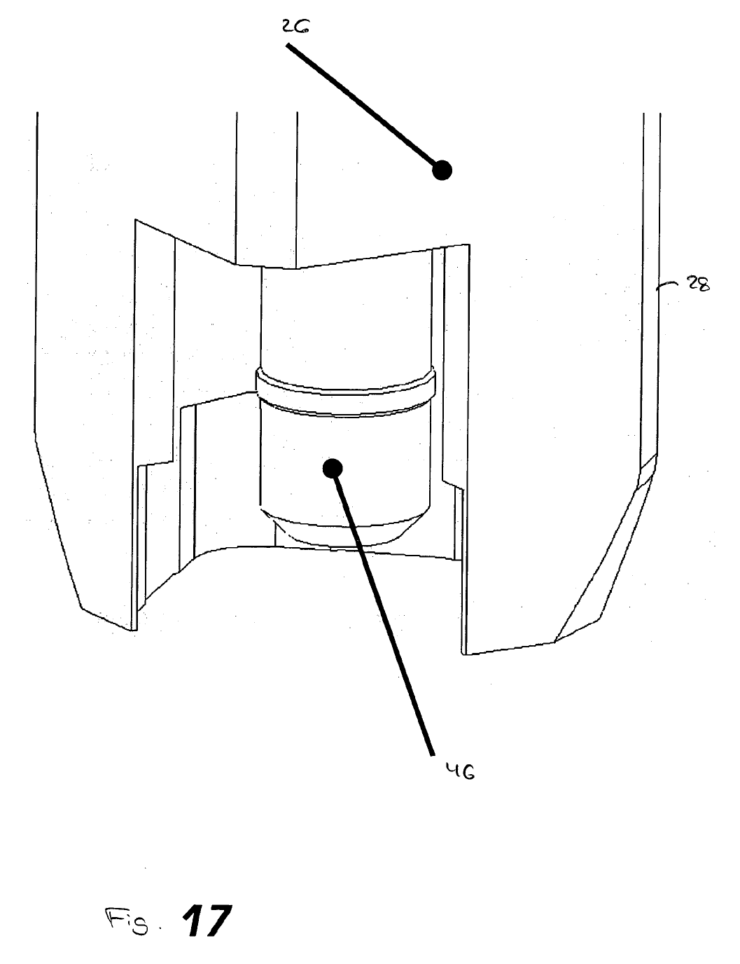

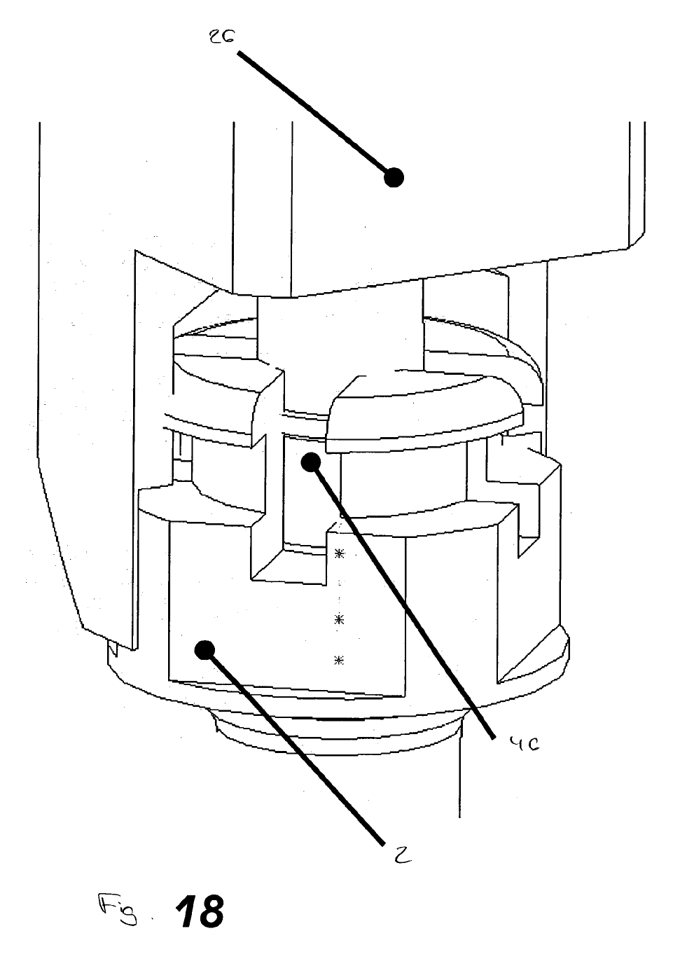

FIG. 17 and FIG. 18 show a tool for receiving and aligning the screw head with a receiver pin,

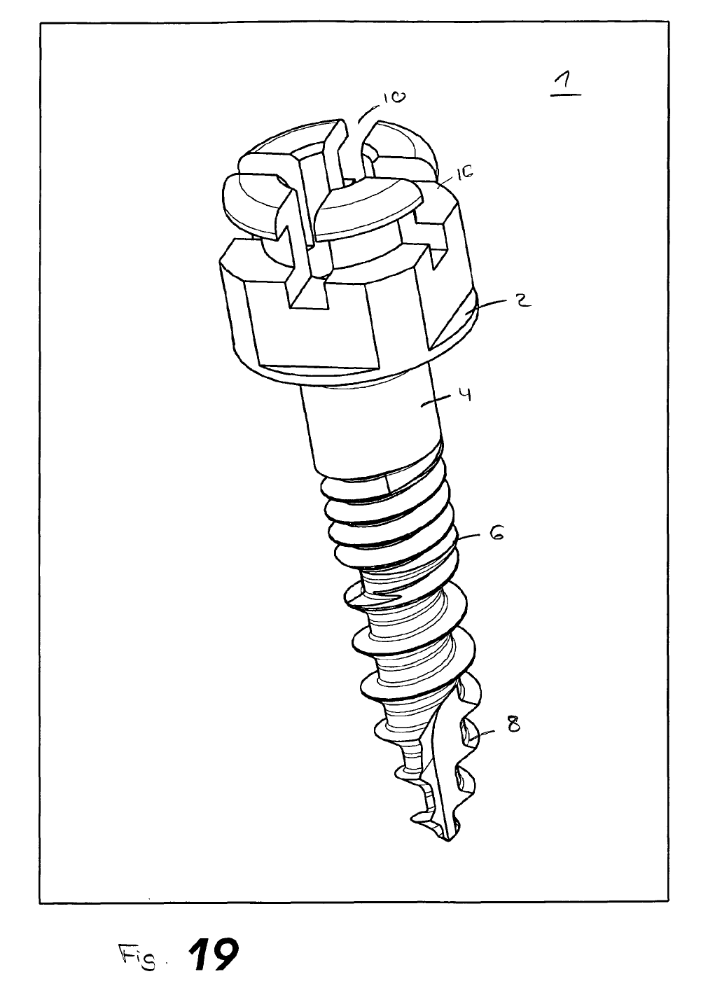

FIG. 19 shows an orthodontic anchoring screw with a variable thread region.

In the orthodontic anchoring screw 1 according to FIG. 1, there is a transition region 4 adjacent to the screw head 2, before the anchoring screw 1 passes into a threaded region 6. The start of the screw thread 8 is adjacent to the lower end of the threaded region 6. During the treatment, the anchoring screw is screwed into the jaw, and due to the positive connection with the surrounding bone material of the jaw, provides the possibility of anchoring during treatment for tooth displacement. A tooth to be treated is, for example, held under tension by means of wires and thus pulled and/or rotated into the desired position. For this purpose, on the anchoring screw these wires are fixed to the anchoring screw.

In the screw head 2 of the orthodontic anchoring screw according to FIG. 2, therefore, a recess is shown in the form of a groove 10. Such a groove is inserted—as is also shown in FIG. 2—into the screw head, preferably at right angles to the screw axis. The screw head 2 according to FIG. 2 further comprises a base body 12 from which an upper body 14 extends. In the transition region between the base body 12 and the upper body 14 a recess in the form of a fixing groove 16 is introduced. The groove 10 used for fixing the wire divides the upper body into two halves in the screw head 2 according to FIG. 2, and penetrates as far as the base body 12 of the screw head 2.

The screw head 2 according to FIG. 3 contains, in addition to that according to FIG. 2, an additional groove 10 which is arranged both at right angles to the screw axis and to the first groove 10. This permits the insertion of a wire from a plurality of directions. However, when using a plurality of grooves the upper body 14 of the screw head 2 is also weakened and the risk of breaking substantially increased. Thus, the number of grooves is generally restricted to two, which are arranged in a cross-shaped configuration—as shown in FIG. 3.

In the screw head 2 according to FIG. 4, a fixing wire 18 is already ligated into one of the grooves. Generally, these fixing wires 18 have a round or rectangular cross-sectional surface. With rectangular cross-sectional surfaces, rectangular embodiments with edge lengths of 0.22 m and 0.19 mm are preferably used. The advantage of rectangular cross-sectional surfaces of the fixing wires 18 is that, when inserted into a groove 10 which only slightly exceeds the edge length of the fixing wire 18, the fixing wire 18 is secured against rotational displacements due to the geometrically adapted groove 10. In a fixing wire 18 with a round cross-sectional surface, however, additional securing against rotational movements has to be carried out.

Security against translatory displacements, i.e. displacements along the groove 10, may be achieved according to the invention by a plastic deformation of the fixing wire 18 with corresponding recesses in the upper body 14 of the screw body. For this purpose, the fixing wire 18 is altered in its cross-sectional geometry by plastic deformation. Such a plastically deformed wire is shown in FIGS. 5 to 7. A plastic deformation and or shaping may lead to different alterations to the geometry of the wire. The wire may be curved or bent back once or repeatedly, and additionally or solely thickened or thinned (FIG. 5a, 5b, 5c). Preferably pliers are used for the plastic deformation. These pliers are designed so that although they deform the fixing wire 18 at the desired point, said fixing wire does not break. For this purpose, the pliers are adapted to the geometric conditions of the fixing wire 18. The narrowing of an edge length achieved during plastic deformation by pliers results in a widening of the edges perpendicular thereto. As a result, a widened region 20 is produced which together with corresponding recesses on the screw head forms a locking mechanism. As a result, the fixing wire 18 is also protected against translatory displacements along the groove 10.

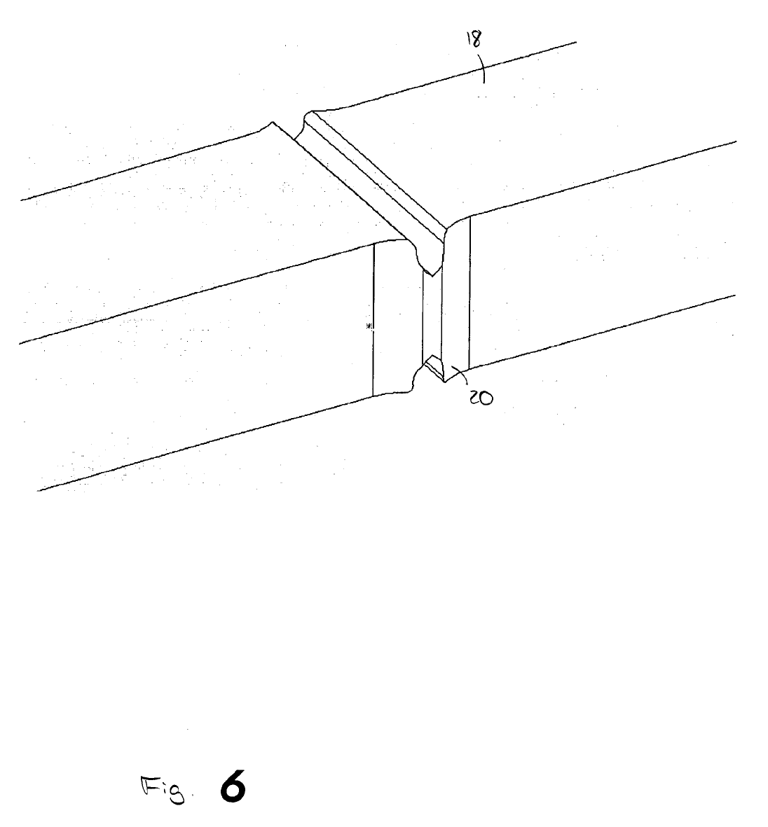

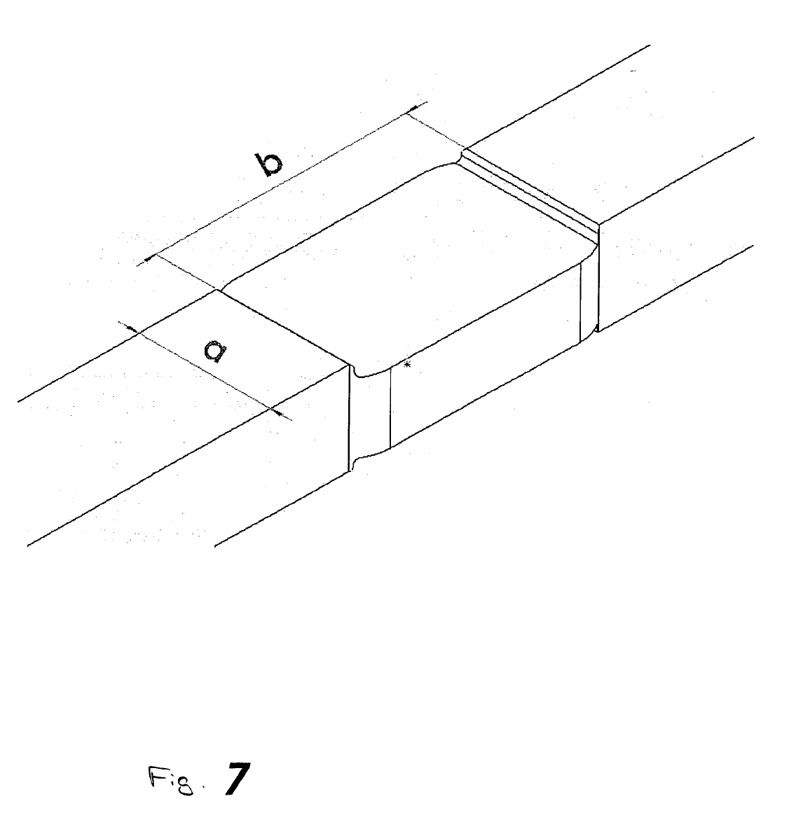

As disclosed above, the fixing wire 18 is thickened, during a squeezing, pressing and/or shearing process, in a direction perpendicular to the operating direction of the squeezing, pressing or shearing process. If the surface of the thinned and thickened portion is too small, as shown in FIG. 6, this may result in a stress concentration which markedly reduces the stability of the wire. For this reason, the pressing length b, i.e. the length of the deformation in the wire direction, is at least half of the fixing wire width a and/or the fixing wire height. Preferably, as also shown in the fixing wire 18 according to FIG. 7, the pressing length b is nevertheless greater than the fixing wire width a and/or fixing wire height.

The screw head 2 according to FIG. 8 has a fixing recess 22, which is incorporated into the upper body 14 and extends on both sides of the groove 10. A fixing wire 18 which has been plastically deformed previously—for example by a corresponding pair of pliers—is then inserted from above into the groove 10 of the screw head 2, the widened region 20 of the fixing wire 18 being located in the fixing recess 22. As a result, the fixing wire 18 is secured against translatory displacements along the groove 10.

For additional securing against a translatory displacement along the screw axis, i.e. securing against the fixing wire 18 being dislodged, the screw head 2 has a fixing groove 16. After the insertion of the fixing wire 18, a securing element, for example a rubber band, is inserted into this fixing groove 16 and protects the fixing wire 18 against being dislodged from the groove 10. The fixing wire 18 is, as a result, ligated into the screw head 2. In this context, the fixing groove ideally has a peripheral depth of at least 0.3 mm, preferably greater than 0.4 mm, and in particular a depth of greater than 0.5 mm. The fixing wire may, however, also be fastened by bonding-in, by winding the fixing wire 18 itself or a different wire around the screw head or by different auxiliary means.

The shape of the fixing recess 22 in FIG. 8 may, therefore, be designed differently and, for example, be round or rectangular depending on the intended use and/or the plastic deformation of the wire. Concave or convex shapes or other geometric shapes are also conceivable.

Cutting tools are suitable for producing such a fixing recess 22. Preferably, therefore, the fixing recess 22 is drilled, turned, milled, sanded, polished, shaped and/or punched. The fixing recess 22 may, however, also be produced by other material-removing methods, such as for example laser processing, spark erosion, etching, electrolytic etching. Furthermore, methods altering the shape, such as for example forming and or bending, are also suitable. In a single groove 10—as shown in FIG. 8—a bore and/or countersink may result which at least partially alters the groove 10 in its width and or depth.

Two centrally intersecting grooves 10 are suitable for simplifying the insertion of fixing wires 18 into the screw head 2. In this case, the fixing wires 18 are generally inserted in the direction of the dental arch. For screwing in the orthodontic anchoring screw 1, planar side surfaces 24 are advantageously located on the base body 12 of the screw head 2, in which surfaces the tool 26 engages for screwing in the anchoring screw 1. However, this has the result that when screwing in the anchoring screw 1 the tool 26 covers the grooves 10 and it is not possible for the doctor providing the treatment to align the grooves 10 according to requirements.

The screw head 2 according to FIG. 9 thus has twice as many side surfaces 24 as grooves 10, but may also have a further non-circular outer contour, and the corresponding tool 26 has a correspondingly adapted internal contour of the receiver channel. These side surfaces form, as a result, a referencing zone for the tool 26. Because two grooves, which together form a cross-shaped groove, are used in the screw head 2 according to FIG. 9, the tool 26 used for screwing in has four options for positioning on the screw head 2. In a cross-shaped groove, therefore, a square tool is suitable for inserting the anchoring screw 1 into the jaw bone. Thus, the tool 26 is provided in the outer region with four marking surfaces 28, which are positioned so as to correspond to the alignment of the cross-shaped groove. Via these marking surfaces the doctor providing the treatment may obtain information about the position of the cross-shaped groove. It is thus possible for the doctor to carry out the desired positioning of the grooves without having to remove the tool 26 from the screw head 2 during insertion.

The fixing recesses 22 may be inserted by the above-described method even when using a plurality of grooves 10. The fixing recess 22 may thus refer to only one groove 10 or a part of a groove 10. The shape of the fixing recess 22 may adopt different geometries, as disclosed in the single groove 10. Ideally, however, the fixing recess is located on the central point of intersection of the grooves 10. When two grooves 10 intersect—as shown in the screw head according to FIG. 10—at the point of intersection four corners are produced, which each have an angle of approximately 90°, and have internal edges 30 extending downwards. The upper body 14 is, as a result, separated into four regions.

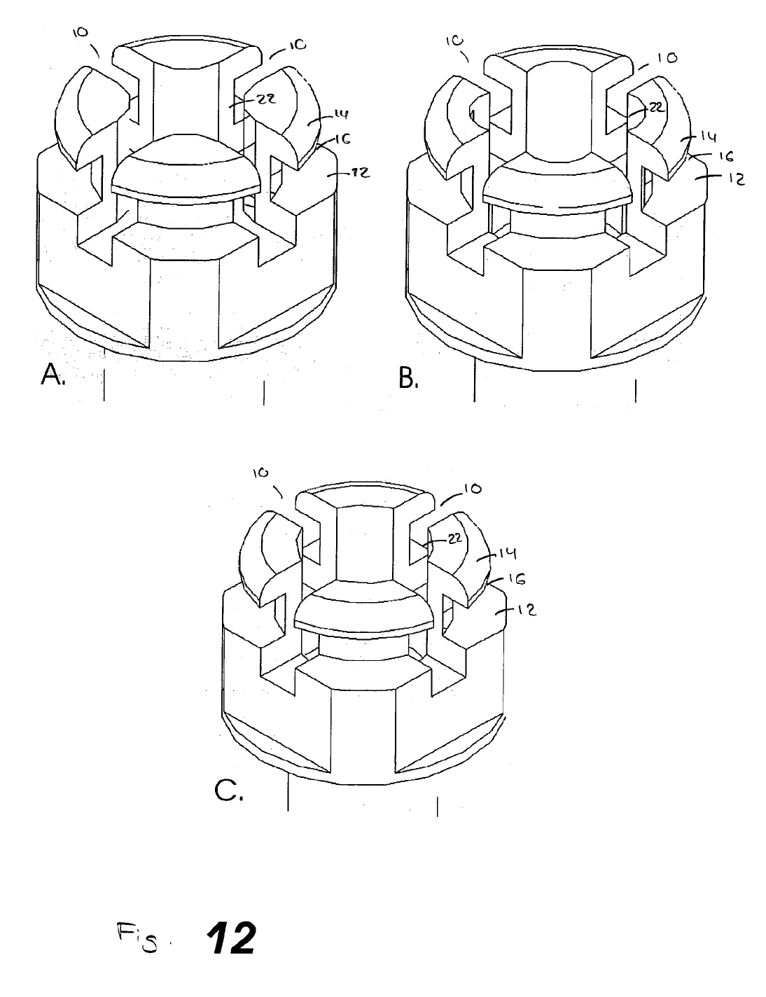

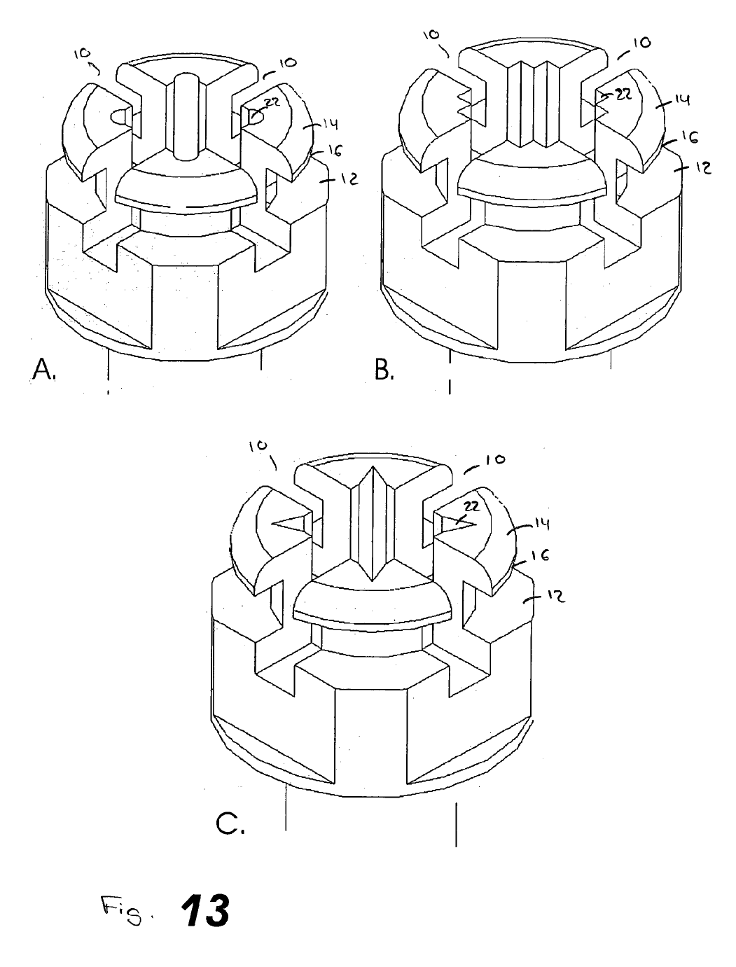

For producing the fixing recess 22, the internal edges 30 of the four regions of the upper body 14 are abraded or shaped by one of the already disclosed methods. In this manner, the spacing of the non-adjacent regions of the upper body 14 increases. The alteration of the spacing may thus be less than 0.2 mm, but preferably greater than 0.3 mm and in particular greater than 0.4 mm. The abrasion and/or shaping of the internal edges 30 may thus take place in a plurality of operating steps and the fixing recesses 22 may have different radii and shapes. Thus, amongst others, concave shapes, convex shapes (FIGS. 12a, 12b, 12c), inwardly or outwardly inclined inner edges or even meandering shapes (FIGS. 13a, 13b, 13c) are conceivable. Combinations thereof or other geometric shapes are also conceivable. Said fixing recess 22 produced by abrasion or shaping should preferably be designed to extend at least as far as the base of the groove 10, but may also be designed to be deeper than the groove 10, in a particularly advantageous variant.

A variant which is very easy to produce and particularly advantageous provides a round fixing recess 22 which is preferably positioned in the centre of the groove intersection. Such a design may be produced via a standard bore or an end bore. This simplifies the production and produces a locking mechanism with many variants of the fixing wire deformation and/or shaping. The bore depth may be less than, equal to or greater than the groove depth.

The round, central fixing recess 22, which preferably is positioned on the point of intersection of the two grooves, has further advantages. With this shaping, which is preferably round and in the form of a bore, components such as, for example, a fixing pin 32 according to FIG. 14 may be inserted alone or together with a fixing wire 18 into the screw head 2. The fixing pin 32 according to FIG. 14 thus has a centring pin 34 adapted to the fixing recess 22. This centring pin 34 preferably has, corresponding to the fixing recess 22, a round cross section which simplifies the insertion of the fixing pin 32 into the screw head 2. The fixing pin 32 has, moreover, a number of side arms 36 which when the fixing pin is inserted—as shown in FIG. 15—engage in the groove 10, which is transverse to the groove 10, which is provided with the fixing wire 18. As a result, the fixing pin 32 is secured against rotational displacements about its axis. The fixing pin 32, together with the fixing wire 18, is protected by the fixing groove 16 against being dislodged. In this context, a fixing element is used—in the embodiment according to FIG. 15 this is a rubber ring 38—which is located in the fixing groove 16.

The fixing pin, moreover, has a receiver head 40 and a receiver groove 42. By means of this receiver head additional clamping elements 44 may—as shown in FIG. 16—be fastened to the anchoring screw 1, and thus a plurality of teeth treated at the same time via one anchoring screw 1. In this context wires, rubber bands, springs and other force-exerting elements are examples of possible additional clamping elements. A substantial advantage of the fixing pin 32 according to the invention is, therefore, that all clamping elements generally used by an orthodontist may be easily and securely fastened to an anchoring screw 1. By the common fastening and/or ligating of a fixing wire 18 and a fixing pin 32, there is even the possibility of fastening a plurality of clamping elements at the same time, as shown in FIG. 16. With this application, the large number of different screw types may be reduced and with the use of only one screw, a plurality of teeth may be pushed in different directions. Otherwise, a plurality of treatment steps would have to be carried out consecutively, and if it were not possible for all of the force-exerting elements conventionally used to be fastened and/or ligated onto a screw, in a further treatment step a screw might have to be removed from the jaw and replaced by a screw with a different screw head.

A round fixing recess 22, for example through a bore, has a further advantage. Before the screw is screwed into the jaw, the screws are generally located in a holder, which is referred to as a trail. For simplified handling of the screw, it is advantageous if the screw is able to be fastened to the tool 26 provided for screwing into the bone, so that the orthodontic anchoring screw 1 may not be dislodged from the tool 26. In order to achieve this, therefore, the tool according to FIG. 17 has a receiver pin 46. Said pin may be inserted into the fixing recess 22 of the screw head 2, and thus produces a non-positive connection between the anchoring screw 1 and the tool 26. If the contact points between the receiver pin 46 and the cross-shaped groove are small, the wear on the fixing recess 22 is greater than if the area between the receiver pin 46 and the cross-shaped groove were large. If the fixing recess 22 at the point of intersection of the cross-shaped groove has a round cross-sectional surface, for example formed by a bore, the contact surface is maximised (FIG. 18) and the wear of the fixing recess is minimised. This leads to a long service life of the tools 26 and the anchoring screws 1.

In the orthodontic anchoring screw 1 according to FIG. 19, in a particularly advantageous embodiment the screw head 2 is provided with a cross-shaped groove, a fixing groove 16 and an additional fixing recess 22 in the form of a central bore and formed on a shank provided with a multiple thread. This multiple thread advantageously has, in addition to the single thread, a double or multiple thread which preferably is attached in the direction of the screw head. The double or multiple thread improves the primary stability above all, but also the secondary stability of the screw in the bone. Because with a plurality of force-exerting elements greater forces and loads are exerted on the screw and thus on the bond between the screw and bone than if only one force-exerting element were attached, an improved stability of the screw in the bone proves advantageous. Advantageously, the cross-shaped groove has a width of more than 0.55 mm and a depth of more than 1 mm, but in particular more than 1.2 mm, and has a central fixing recess 22, preferably produced by a bore, with a diameter greater than 1 mm, but preferably greater than 1.2 mm. In a head with these properties, a wire which is rectangular in profile may be ligated with a rubber band generally used by orthodontists, and locked against displacement via plastic deformation in the direction of the inserted groove 10.

### LIST OF REFERENCE NUMERALS

1 Orthodontic anchoring screw
2 Screw head
4 Transition region
6 Threaded region
8 Start of threaded region
10 Groove
12 Base body
14 Upper body
16 Fixing groove
18 Fixing wire
20 Widened region
22 Fixing recess
24 Side surfaces
26 Tool
28 Marking surface
30 Internal edges
32 Fixing pin
34 Centring pin
36 Side arm
38 Rubber band
40 Receiver head
42 Receiver groove
44 Clamping element
46 Receiver pin
a Fixing wire width
b Pressing length

1. A fixing wire, in particular for applying treatment forces to a tooth, which wire has a widened region produced by plastic deformation for the longitudinal fixing thereof in a corresponding fixing recess of an orthodontic anchoring screw.

2. The fixing wire according to claim 1, which has a rectangular cross section.

3. Use of a pair of pliers for producing the widened region of a fixing wire according to claim 1.

4. An orthodontic tooth alignment system comprising a fixing wire according to claim 1, and an orthodontic anchoring screw which has in its screw head a fixing recess provided for receiving the widened region.

5. An orthodontic anchoring screw for use in a system according to claim 4, the screw head thereof comprising a groove for receiving a fixing wire according to either claim 1, the groove being designed to be locally widened to form the fixing recess.

6. An orthodontic anchoring screw according to claim 5, comprising the screw head thereof in a referencing zone a non-circular outer contour.

7. A tool for fastening an orthodontic anchoring screw according to claim 6 in the jaw bone, with a number of marking surfaces visible from the outside, the marking surfaces being arranged corresponding to the orientation of the groove of the screw head of the orthodontic anchoring screw and with a receiver channel adapted in its internal contour to the outer contour of the referencing zone.

8. The tool according to claim 7, comprising a receiver pin, the receiver pin being designed for producing a positive connection with the fixing recess of the orthodontic anchoring screw.

9. A fixing pin comprising a centring pin for use in combination with an orthodontic anchoring screw according to claim 5, the centring pin being designed for positioning in the fixing recess.
